(19) United States
(12) Patent Application Publication
(10) Pub. No.: US 2011/0078600 A1
(43) Pub. Date: Mar. 31, 2011

(54) Modification Free Tagging of Business Application User Interfaces

(75) Inventors: Jochen Guertler, Karlsruhe (DE); Thomas Chadzelek, St. Ingbert (DE)

(73) Assignee: SAP AG, Walldorf (DE)

(21) Appl. No.: 12/571,116

(22) Filed: Sep. 30, 2009

(51) Int. Cl. G06F 3/048; G06F 9/46

(52) U.S. Cl. 715/765; 719/315

(57) ABSTRACT

The present disclosure involves systems, software, and computer implemented methods for modification free tagging of business application user interfaces. One process includes operations for receiving a selection of a particular user interface element for tagging. If at least one bound data object is associated with the selected user interface element, tagging data for the bound data object is received. The tagging data is stored in the personalization settings of the application, and a listener function associated with the bound data object is defined.

### TECHNICAL FIELD

The present disclosure relates to software, computer systems, and computer implemented methods for tagging of business application user interfaces that is substantially modification free.

### BACKGROUND

Data objects can be tagged with additional data or information for extended functionality or identification of the data objects. The tagged data can be additional descriptive information or data identifying a particular application or module that can be linked to the output of the data object. When tagged data links the data object to an application, the application can be executed based on information contained within the data object. In general, applications that support tagging of data objects were designed to be used with tagging features. There are also pre-existing applications that were not originally designed to support tagging of data objects used by the applications. Implementing tagging functionality in the pre-existing applications, however, would require modifying those applications.

### SUMMARY

The present disclosure provides techniques for modification free tagging of business application user interfaces (UI). A computer program product is encoded on a tangible storage medium, where the product comprises computer readable instructions for causing one or more processors to perform operations. These operations can include receiving a selection of a particular user interface element for tagging. If at least one bound data object is associated with the selected user interface element, tagging data for the bound data object is received. The tagging data is stored in the personalization settings of the application, and a listener function associated with the bound data object is defined.

While generally described as computer implemented software embodied on tangible media that processes and transforms the respective data, some or all of the aspects may be computer implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 illustrates an example environment implementing various features of modification free user interface (UI) injection into an application within the context of the present disclosure;

FIG. 2 is a flow chart of an example process of initializing an application with an injected UI component using an appropriate system, such as the system described in FIG. 1;

FIG. 3 is a flow chart of an example process of injecting a new UI component using an appropriate system, such as the system described in FIG. 1;

FIGS. 4A-C are example screenshots of an example UI injection process performed on a selected UI element of an application by an appropriate system, such as the system described in FIG. 1.

FIG. 5 is a flow chart of an example process of initializing an application with data objects that have been tagged using an appropriate system, such as the system described in FIG. 1;

FIG. 6 is a flow chart illustrating the process of adding a new tag to a data object using an appropriate system, such as the system described in FIG. 1;

FIG. 7 is a flow chart illustrating the processing of tagged data using an appropriate system, such as the system described in FIG. 1;

FIGS. 8A-D are example screenshots of an example tagging process performed on a selected UI element of an application by an appropriate system, such as the system described in FIG. 1; and

FIGS. 9A-D are example screenshots of an example UI injection and tagging process performed on a selected component of an application by an appropriate system, such as the system described in FIG. 1.

### DETAILED DESCRIPTION

This disclosure generally describes computer systems, software, and computer implemented methods for applying tagging data to data objects. Tagging data can be applied to data objects used by an application even if the application does not originally implement tagging of data objects, that is, even if the application was not originally designed with tagging capabilities. The tags that are applied to data objects can be merely descriptive of the data object, or the tags can comprise additional data linking the data object to an application or module. The tagging data applied to data objects help facilitate user-intuitive extension of the functionality of current applications that do not necessarily have tagging capabilities. In some instances, the tagging module utilizes the existing personalization infrastructure of the hosted application to apply tagging data to data objects used by hosted application. The tagging data is not stored for a user interface (UI) element or a field of the UI element but for bound data objects underlying the UI element. The tagging data is stored in the same way as any other kind of personalization UI.

In certain implementations, a particular UI element of an application is selected for tagging. If there is a bound data object available for the selected UI element, tagging data is received from a user. The application's runtime environment or a UI framework then stores the tagging data and location as persistent personalization data in the application's personalization settings. A data object listener can also be defined for the bound data object, which ensures that changes to the bound data object or a selection of the bound data object automatically results in updating any modules associated with the bound data object with the newly updated information.

One potential benefit of such techniques is that an application may be used to apply tagging data to UI elements in the application, even if the application does not have existing tagging capabilities. Existing business applications, for example, may not inherently provide support for tagging data. Still further, when changes are made to tagged data objects, existing applications may not automatically apply those changes to any existing modules associated with the tagged data objects. Using modification-free tagging of UI elements, however, the functionality of existing applications may be enhanced by allowing various UI elements to be tagged and linked with modules or mashable components. Further, instead of modifying the application to implement tagging capabilities, the tagging data and relevant tagging information are handled as personalization data for the application. Thus, the application can incorporate tagging functions into the application's UI but the application itself is not modified to implement the tagging capabilities. One direct benefit of allowing existing applications to incorporate tagging elements without modifying the application is that the application can be upgraded as needed but still be used essentially as an application with tagging capabilities. Another possible benefit of utilizing personalization data for implementing modification free tagging of business application UI elements is that, for the user, the process is not bound to a particular programming skill, such as for example Hyper Text Markup Language (HTML) or JavaScript, and does not require specific technical skills of the user.

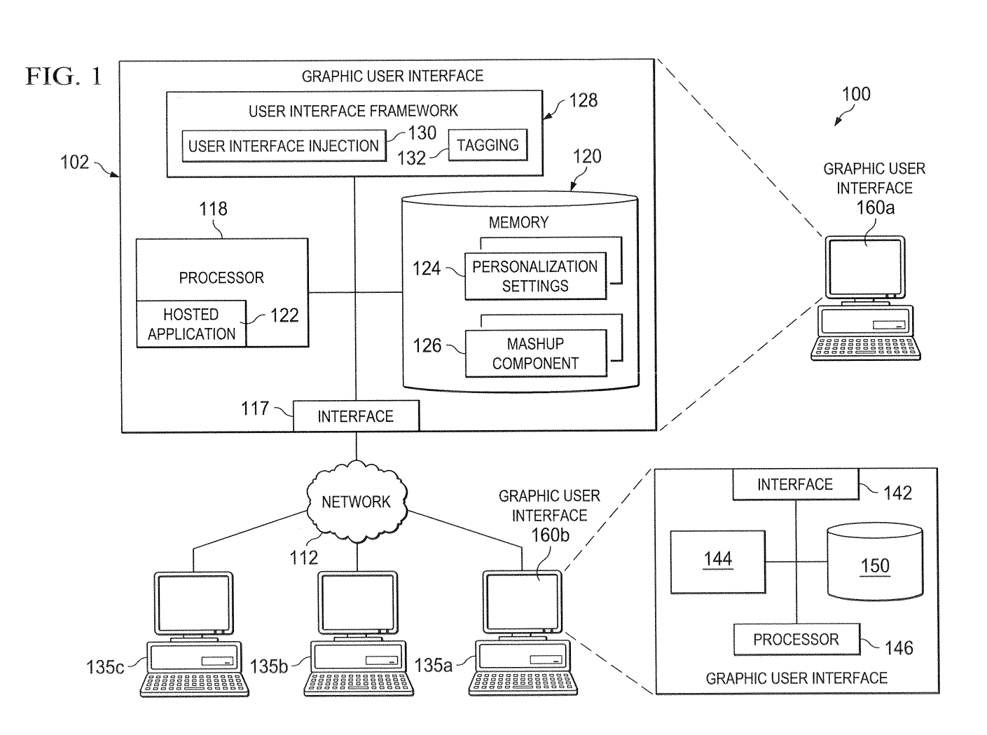

Turning to the illustrated example, FIG. 1 illustrates an example environment 100 for modification-free UI injection into a business application and modification-free tagging of UI elements. The illustrated environment 100 includes or is communicably coupled with server 102 and one or more clients 135, at least some of which communicate across network 112. In general, environment 100 depicts an example configuration of a system capable of providing a mashup workspace using the UI of an existing application, regardless of whether the existing application has inherent mashup capabilities. The environment 100 also supports a system capable of providing tagging capabilities for tagging UI elements in an application.

In general, server 102 is any server that stores one or more hosted applications 122, where at least a portion of the hosted applications 122 are executed via requests and responses sent to users or clients within and communicably coupled to the illustrated environment 100 of FIG. 1. For example, server 102 may be a Java 2 Platform, Enterprise Edition (J2EE)-compliant application server that includes Java technologies such as Enterprise JavaBeans (EJB), J2EE Connector Architecture (JCA), Java Messaging Service (JMS), Java Naming and Directory Interface (JNDI), and Java Database Connectivity (JDBC). In some instances, the server 102 may store a plurality of various hosted applications 122, while in other instances, the server 102 may be a dedicated server meant to store and execute only a single hosted application 122. In some instances, the server 102 may comprise a web server, where the hosted applications 122 represent one or more web-based applications accessed and executed via network 112 by the clients 135 of the system to perform the programmed tasks or operations of the hosted application 122.

At a high level, the server 102 comprises an electronic computing device operable to receive, transmit, process, store, or manage data and information associated with the environment 100. The server 102 illustrated in FIG. 1 can be responsible for receiving application requests from one or more client applications 144 associated with the clients 135 of environment 100 and responding to the received requests by processing said requests in the associated hosted application 122, and sending the appropriate response from the hosted application 122 back to the requesting client application 144. Alternatively, the hosted application 122 at server 102 can be capable of processing and responding to local requests from a user accessing server 102 locally. Accordingly, in addition to requests from the external clients 135 illustrated in FIG. 1, requests associated with the hosted applications 122 may also be sent from internal users, external or third-party customers, other automated applications, as well as any other appropriate entities, individuals, systems, or computers.

As used in the present disclosure, the term “computer” is intended to encompass any suitable processing device. For example, although FIG. 1 illustrates a single server 102, environment 100 can be implemented using two or more servers 102, as well as computers other than servers, including a server pool. Indeed, server 102 may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, illustrated server 102 may be adapted to execute any operating system, including Linux, UNIX, Windows, Mac OS, or any other suitable operating system. According to one embodiment, server 102 may also include or be communicably coupled with a mail server.

In the present implementation, and as shown in FIG. 1, the server 102 includes a processor 118, an interface 117, a memory 120, and one or more hosted applications 122. The interface 117 is used by the server 102 for communicating with other systems in a client-server or other distributed environment (including within environment 100) connected to the network 112 (e.g., client 135, as well as other systems communicably coupled to the network 112). Generally, the interface 117 comprises logic encoded in software and/or hardware in a suitable combination and operable to communicate with the network 112. More specifically, the interface 117 may comprise software supporting one or more communication protocols associated with communications such that the network 112 or interface's hardware is operable to communicate physical signals within and outside of the illustrated environment 100.

The server may also include a user interface, such as a graphical user interface (GUI) 160a. The GUI 160a comprises a graphical user interface operable to, for example, allow the user of the server 102 to interface with at least a portion of the platform for any suitable purpose, such as creating, preparing, requesting, or analyzing data, as well as viewing and accessing source documents associated with business transactions. Generally, the GUI 160a provides the particular user with an efficient and user-friendly presentation of business data provided by or communicated within the system. The GUI 160a may comprise a plurality of customizable frames or views having interactive fields, pull-down lists, and buttons operated by the user. For example, GUI 160a may provide interactive elements that allow a user to intuitively select a UI component 126 for insertion into the UI of hosted application 122. More generally, GUI 160a may also provide general interactive elements that allow a user to access and utilize various services and functions of application 122. The GUI 160a is often configurable, supports a combination of tables and graphs (bar, line, pie, status dials, etc.), and is able to build real-time portals, where tabs are delineated by key characteristics (e.g. site or micro-site). Therefore, the GUI 160a contemplates any suitable graphical user interface, such as a combination of a generic web browser, intelligent engine, and command line interface (CLI) that processes information in the platform and efficiently presents the results to the user visually.

Generally, example server 102 may be communicably coupled with a network 112 that facilitates wireless or wireline communications between the components of the environment 100 (i.e., between the server 102 and the clients 135), as well as with any other local or remote computer, such as additional clients, servers, or other devices communicably coupled to network 112 but not illustrated in FIG. 1. The network 112 is illustrated as a single network in FIG. 1, but may be a continuous or discontinuous network without departing from the scope of this disclosure, so long as at least a portion of the network 112 may facilitate communications between senders and recipients. The network 112 may be all or a portion of an enterprise or secured network, while in another instance at least a portion of the network 112 may represent a connection to the Internet. In some instances, a portion of the network 112 may be a virtual private network (VPN), such as, for example, the connection between the client 135 and the server 102. Further, all or a portion of the network 112 can comprise either a wireline or wireless link. Example wireless links may include 802.11a/b/g/n, 802.20, WiMax, and/or any other appropriate wireless link. In other words, the network 112 encompasses any internal or external network, networks, sub-network, or combination thereof operable to facilitate communications between various computing components inside and outside the illustrated environment 100. The network 112 may communicate, for example, Internet Protocol (IP) packets, Frame Relay frames, Asynchronous Transfer Mode (ATM) cells, voice, video, data, and other suitable information between network addresses. The network 112 may also include one or more local area networks (LANs), radio access networks (RANs), metropolitan area networks (MANs), wide area networks (WANs), all or a portion of the Internet, and/or any other communication system or systems at one or more locations. The network 112, however, is not a required component of the present disclosure.

As illustrated in FIG. 1, server 102 includes a processor 118. Although illustrated as a single processor 118 in FIG. 1, two or more processors may be used according to particular needs, desires, or particular embodiments of environment 100. Each processor 118 may be a central processing unit (CPU), a blade, an application specific integrated circuit (ASIC), a field-programmable gate array (FPGA), or another suitable component. Generally, the processor 118 executes instructions and manipulates data to perform the operations of server 102 and, specifically, the one or more plurality of hosted applications 122. Specifically, the server's processor 118 executes the functionality required to receive and respond to requests from the clients 135 and their respective client applications 144, as well as the functionality required to perform the other operations of the hosted application 122.

Regardless of the particular implementation, “software” may include computer-readable instructions, firmware, wired or programmed hardware, or any combination thereof on a tangible medium operable when executed to perform at least the processes and operations described herein. Indeed, each software component may be fully or partially written or described in any appropriate computer language including C, C++, Java, Visual Basic, assembler, Perl, any suitable version of 4GL, as well as others. It will be understood that while portions of the software illustrated in FIG. 1 are shown as individual modules that implement the various features and functionality through various objects, methods, or other processes, the software may instead include a number of sub-modules, third party services, components, libraries, and such, as appropriate. Conversely, the features and functionality of various components can be combined into single components as appropriate. In the illustrated environment 100, processor 118 executes one or more hosted applications 122 on the server 102.

At a high level, each of the one or more hosted applications 122 is any application, program, module, process, or other software that may execute, change, delete, generate, or otherwise manage information according to the present disclosure, particularly in response to and in connection with one or more requests received from the illustrated clients 135 and their associated client applications 144. In certain cases, only one hosted application 122 may be located at a particular server 102. In others, a plurality of related and/or unrelated hosted applications 122 may be stored at a single server 102, or located across a plurality of other servers 102, as well. In certain cases, environment 100 may implement a composite hosted application 122. For example, portions of the composite application may be implemented as Enterprise Java Beans (EJBs) or design-time components may have the ability to generate run-time implementations into different platforms, such as J2EE (Java 2 Platform, Enterprise Edition), ABAP (Advanced Business Application Programming) objects, or Microsoft's .NET, among others. Additionally, the hosted applications 122 may represent web-based applications accessed and executed by remote clients 135 or client applications 144 via the network 112 (e.g., through the Internet). Further, while illustrated as internal to server 102, one or more processes associated with a particular hosted application 122 may be stored, referenced, or executed remotely. For example, a portion of a particular hosted application 122 may be a web service associated with the application that is remotely called, while another portion of the hosted application 122 may be an interface object or agent bundled for processing at a remote client 135. Moreover, any or all of the hosted applications 122 may be a child or sub-module of another software module or enterprise application (not illustrated) without departing from the scope of this disclosure. Still further, portions of the hosted application 122 may be executed by a user working directly at server 102, as well as remotely at client 135.

As illustrated, processor 118 also executes the user interface (UI) framework software 128 for server 102. Similar to hosted application 122, the UI framework 128 may generally be any application, program, module, process, runtime engine, or other software that may execute, change, delete, generate, or otherwise manage information according to the present disclosure, particularly in order to implement modification free UI injection into business applications. The UI framework 128 may be separate from hosted application 122, while in other instances, the UI framework 128 may be embedded within or part of a particular one or more of hosted applications. In some instances, hosted application 122 may be communicably coupled to the UI framework 128, allowing hosted application 122 to access and take advantage of the functionality provided by the UI framework 128. The functionality provided by the UI framework 128 can include providing UI support for development of web representations of business applications, for example.

As illustrated, the UI framework 128 includes a UI injection module 130 and a tagging module 132. These modules may be embedded within the UI framework 128 as shown in FIG. 1, or instead may be communicably coupled to the UI framework 128 within the server 102. In still further instances, either or both of the modules may be located external to the server 102 and perform their relative functionality through communications and interactions facilitated by network 112. Each module may be an agent, daemon, object, service, plug-in, or other software capable of performing the respective module's functionality and operations. Additionally, each module may simply represent a portion of the UI framework 128 (and in some instances, the hosted application's 122) programming, such that the module itself is inseparable from or an integral part of the UI framework 128.

Turning to the first of the two modules, the UI injection module 130 is used by the server 102, in connection with one or more of the hosted applications 122, to inject or insert a mashup component 126 into the UI of a hosted application 122 where the hosted application 122 does not necessarily have preexisting mashup capabilities. A mashup component 126 is an application or a module, subroutine, process, service, or other component of an application that can be combined with other similar components into a new service or arranged in a particular layout along with other components to present a customized arrangement of applications for convenient access to a user. The mashup component 126 can be visually represented as a UI element that is easily moved from one location to another within the GUI 160a. Further, mashup components can also be “mashable” in the sense that they can be linked with other components or with an underlying application for data flow. That is, input and output ports from one mashup component can be connected to input and output ports of another mashup component or application.

In some instances, the UI injection module 130 utilizes the existing personalization infrastructure of the hosted application 122 to inject or combine a mashup component 126 into the UI of the hosted application 122. The personalization infrastructure includes persistent personalization settings that store personalization data for the hosted application 122. Just as personalization data would typically be stored in the persistent personalization settings during normal execution of the hosted application 122, the data associated with the insertion of the mashup components 126 in the hosted application UI is also stored in the persistent personalization settings by the UI injection module 130. The persistent personalization settings allow personalization data to be stored for an application and for changes to the personalization data to remain in effect even after termination of the application. The personalization settings can also be used to generate controls for the mashup component 126 such as a text field or a UI link element. Thus, even when hosted application 122 requires use of the full screen of GUI 160a during runtime, the UI of the hosted application 122 may still be used as a backdrop for including mashup components 126 in the application UI. Further, UI injection of a mashup component 126 into an application using the personalization settings avoids binding the process to a particular programming interface such as Hyper Text Markup Language or JavaScript.

Specifically, the UI injection module 130 can merge an external mashup component 126 into the hosted application's UI by creating a UI container after receiving input from a user indicating the UI element or location in the application's UI that is to be used for receiving the mashup component 126. The parameters of the UI container are added to the UI control tree of the application, and the location of the UI container within the control tree and the mashup component 126 are stored in the persistent personalization settings of the application. Finally, the mashup component 126 is executed within the UI container as an embedded application or embedded component within the hosted application's UI. The injection of the mashup component 126 into the application UI results in the integration of a UI framework 130 standard component or application with the underlying hosted application 122. In other words, the mashup component 126 can be injected into the UI of the hosted application 122 using the personalization settings of the hosted application 122, without requiring a user to have knowledge of particular technical skills. Further, in some implementations, the injected mashup component 126 can be linked to services, modules, subroutines, or other components within hosted application 122 by connecting input or output ports between the mashup component 126 and any components within hosted application 122.

The second module is the tagging module 132 used by the server 102, in connection with one or more of the hosted applications 122, to apply tagging data to data objects used by a hosted application 122 that does not necessarily have preexisting data tagging capabilities. The tags that are applied to data objects can be merely descriptive of the data object, or the tags can be additional data linking the data object to an application such as, for example, a mashup component 126. The tagging data applied to data objects help facilitate user-intuitive extension of the functionality of current applications that do not necessarily have tagging capabilities. In some instances, the tagging module 132 utilizes the existing personalization infrastructure of the hosted application 122 to apply tagging data to data objects used by hosted application 122. The tagging data is not stored for a UI element or a field of the UI element but for bound data objects underlying the UI element. The tagging data is stored in the same way as any other kind of personalization data for the application.

The illustrated environment of FIG. 1 also includes one or more clients 135. Each client 135 may be any computing device operable to connect to or communicate with at least the server 102 and/or via the network 112 using a wireline or wireless connection. Further, as illustrated by client 135a, each client 135 includes a processor 146, an interface 142, a graphical user interface (GUI) 160b, a client application 144, and a memory 150. In general, each client 135 comprises an electronic computer device operable to receive, transmit, process, and store any appropriate data associated with the environment 100 of FIG. 1. It will be understood that there may be any number of clients 135 associated with, or external to, environment 100. For example, while illustrated environment 100 includes three clients (135a, 135b, and 135c), alternative implementations of environment 100 may include a single client 135 communicably coupled to the server 102, or any other number suitable to the purposes of the environment 100. Additionally, there may also be one or more additional clients 135 external to the illustrated portion of environment 100 that are capable of interacting with the environment 100 via the network 112. Further, the term “client” and “user” may be used interchangeably as appropriate without departing from the scope of this disclosure. Moreover, while each client 135 is described in terms of being used by a single user, this disclosure contemplates that many users may use one computer, or that one user may use multiple computers.

As used in this disclosure, client 135 is intended to encompass a personal computer, touch screen terminal, workstation, network computer, kiosk, wireless data port, smart phone, personal data assistant (PDA), one or more processors within these or other devices, or any other suitable processing device. For example, each client 135 may comprise a computer that includes an input device, such as a keypad, touch screen, mouse, or other device that can accept user information, and an output device that conveys information associated with the operation of the server 102 (and hosted application 122) or the client 135 itself, including digital data, visual information, the client application 144, or the GUI 160b. Both the input and output device may include fixed or removable storage media such as a magnetic storage media, CD-ROM, or other suitable media to both receive input from and provide output to users of the clients 135 through the display, namely, the GUI 160b.

As indicated in FIG. 1, client 135c is specifically associated with an administrator of the illustrated environment 100. The administrator 135c can modify various settings associated with one or more of the other clients 135, the server 102, the hosted application 122, and/or any relevant portion of environment 100. For example, the administrator 135c may be able to modify the relevant timeout values associated with web container 124 or each hosted application 122, as well as any web container 124 or hosted application settings, including those associated with error monitors 126. The administrator of the illustrated environment may also execute changes to server 102 directly at the server, using GUI 160a, for example. In the present disclosure, the terms “administrator” and “end user” may be used interchangeably as appropriate without departing from the scope of this disclosure.

In general, the server 102 also includes memory 120 for storing data and program instructions. Memory 120 may include any memory or database module and may take the form of volatile or non-volatile memory including, without limitation, magnetic media, optical media, random access memory (RAM), read-only memory (ROM), removable media, or any other suitable local or remote memory component. Memory 120 may store various objects or data, including classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the server 102 and its one or more hosted applications 122. Further, memory 120 may store personalization settings data 124 used by hosted application 122 for customized injection of mashup components 126 into the hosted application's UI. Still further, memory 120 may include any other appropriate data, such as VPN applications, firmware logs and policies, HTML files, data classes or object interfaces, unillustrated software applications or sub-systems, firewall policies, a security or access log, print or other reporting files, as well as others.

While FIG. 1 is described as containing or being associated with a plurality of elements, not all elements illustrated within environment 100 of FIG. 1 may be utilized in each alternative implementation of the present disclosure. For example, although FIG. 1 depicts a server-client environment implementing a hosted application at server 102 that can be accessed by client computer 135, in some implementations, server 102 executes a local application that features an application UI accessible to a user directly utilizing GUI 160a to inject mashup components 126 to the application UI. Additionally, one or more of the elements described herein may be located external to environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

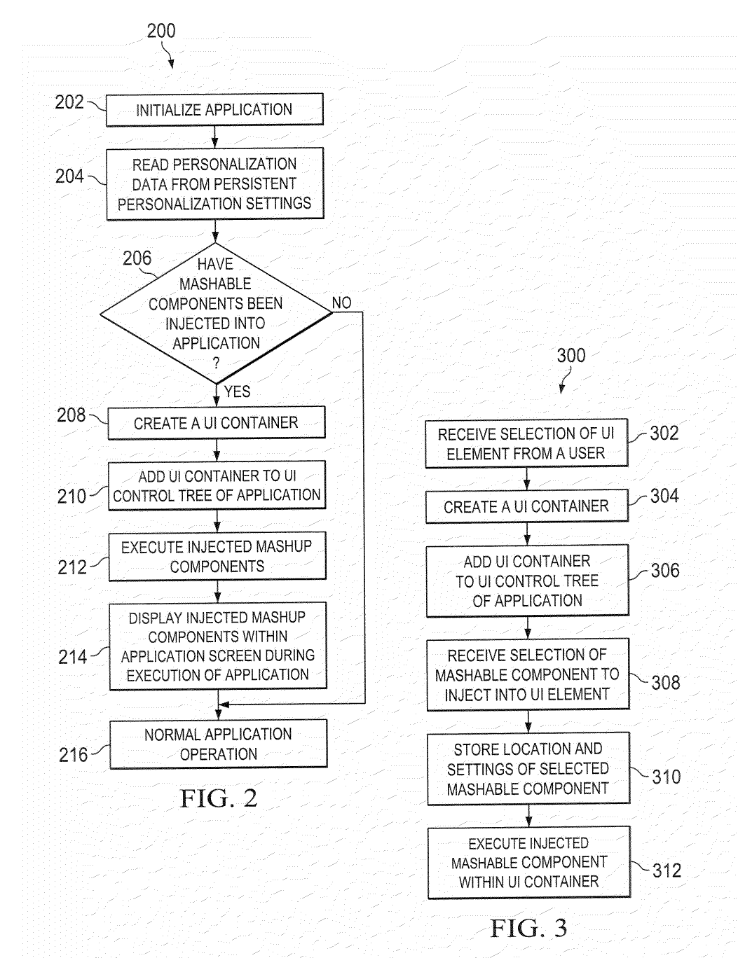

FIG. 2 is a flow chart illustrating the process of initializing an application implementing the modification-free injection methods of the present disclosure. The application 122 is started at 202. The application's runtime environment reads personalization data from the persistent personalization settings 124 for the application 122 at 204. The persistent personalization settings 124 are generally used by the application 122 for personalization of the application's 122 interface and settings for a particular user. In other words, the application 122 can load the personalization settings 124 for the user at runtime of the application 122 to generate the appropriate interface for the user of the application 122. In certain implementations, the application's existing personalization settings 124 infrastructure can also be used to implement a mashable area for insertion of mashable components 126 into the application's UI. Thus, if mashable components 126 have previously been “injected” into the application 122, the personalization settings 124 would include personalization data specific to the insertion of the mashable components 126. The application's runtime environment determines whether the personalization settings indicate any mashable components that have been “injected” into the application 122 at 206. If mashable components have not been injected into the application 122, then the application 122 is executed under normal operations at 216. If personalization data is stored in the personalization settings 124 in connection with a previous mashable component injection, the application runtime environment creates a UI container at 208 and adds the UI container to the UI control tree of the application 122 at 210. The UI control tree is the software code that describes the hierarchy of UI controls for the application 122. Here, the position of the UI container within the control tree is defined in the personalization data. Next, the UI container executes the injected mashable components 126 as part of the application 122 at 212. The application 122 is executed at 214, and the user can view the first screen of the application UI, which includes the injected mashable components 126. The application 122 returns to normal operations at 216.

FIG. 3 is a flow chart illustrating the process of injecting a new mashable component 126 into an application's UI. First, a selection is received from a user for using a particular UI element of the application to contain a mashable component that is to be injected into the application UI at 302. The user may select a particular portion of the application UI to store or receive the mashable component that will be inserted into the application UI. The application runtime environment then creates a UI container at 304 and adds the UI container to a position in the UI control tree as defined by the location of the UI element selected by the user at 306. The position of the UI container in the UI control tree is stored in the persistent personalization settings for the application 122 as any other personalization data for that application 122. At 308, a user can select a mashable component to inject into the UI element. In certain implementations, the selection can be performed through a drag-and-drop technique implemented using a user interface device such as a mouse. After the user has indicated the UI element and location where the mashable component will run, the application runtime environment stores the location and settings of the selected mashable component in the persistent personalization settings at 310. Finally, the UI container executes the injected mashable component within the application at 312.

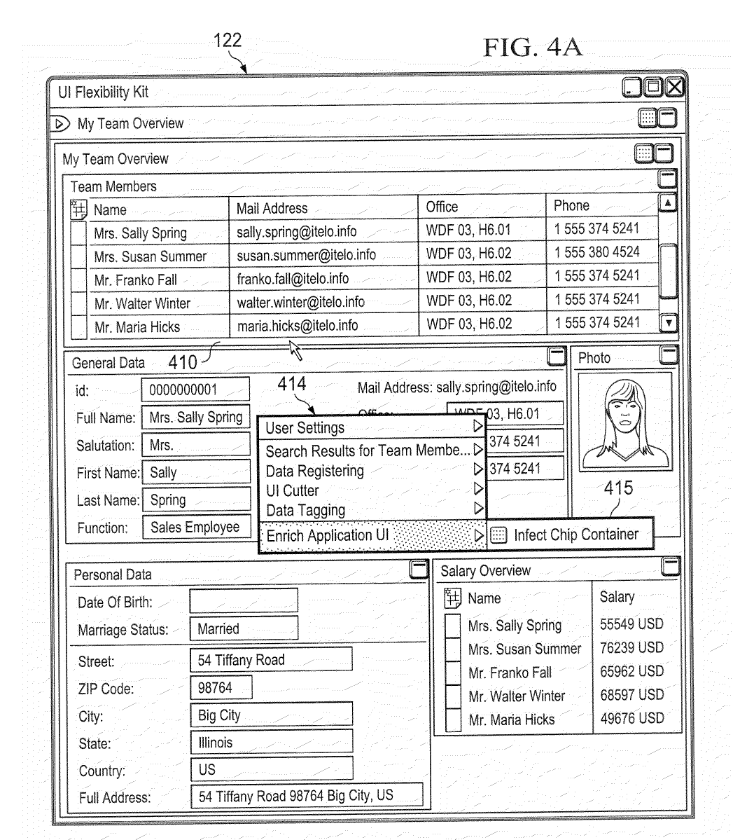

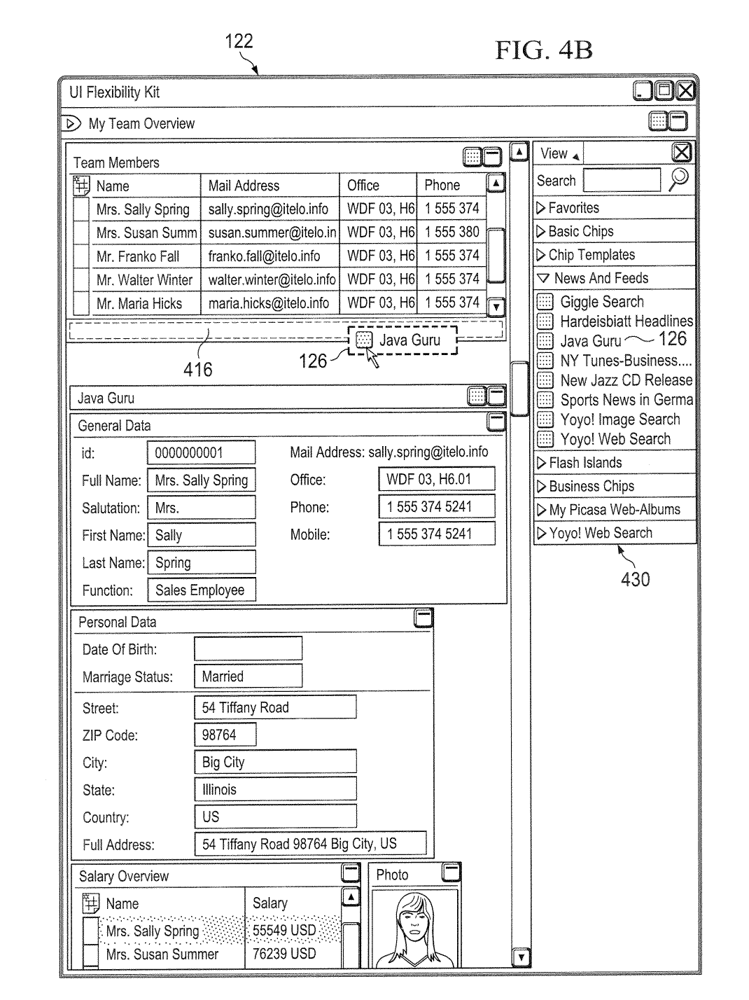

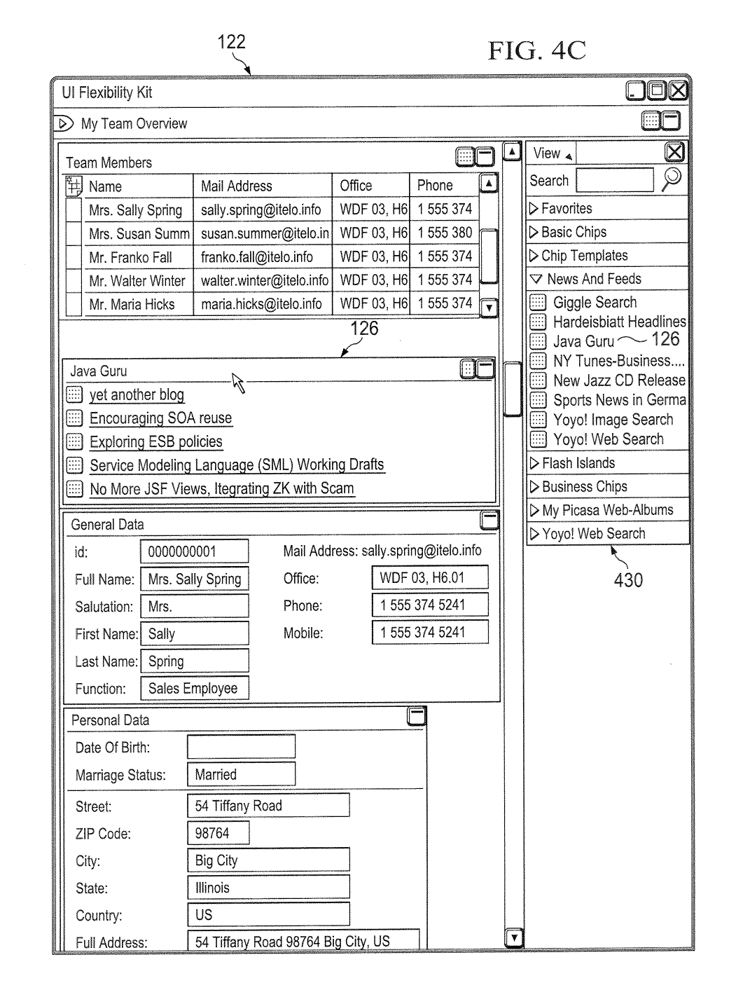

FIGS. 4A-4C depict an example process of injecting a new mashable component 126 into an application's UI from a user's perspective. First, as seen in FIG. 4A, a user selects a particular UI element 410 at which a mashable component 126 can be injected. In the illustrated example, the selected UI element 410 is a particular application component or a module of hosted application 122. In some implementations, any portion of the application UI can be used by UI injection module as a location to inject a mashable component 126. Further, the user's selection of the UI element 410 can be implemented using a variety of methods. In the illustrated example, a context menu 414 can be used to provide the user with a list of options, including a selection 415 to enrich the application UI by inserting a mashable component. Other methods can be used to allow the user to select a particular UI element 410 such as through, for example, a drag-and-drop mechanism or dialog boxes.

As depicted in FIG. 4B, after selection of the UI element 410, a user may be provided with a selection 430 of mashable components as possible components to be injected into the UI element 410 as selected by the user. Further, in some implementations, a wire frame 416 can be generated to represent the targeted location within the UI element 410 that is the future location of an injected mashable component 126. A user can select one of the mashable components 126 from a list 430 or drag a selected mashable component 126 into the wire frame 416 area. Finally, in FIG. 4C, after the UI element 410 and the mashable component 126 have been selected, the mashable component 126 is injected into UI element 410 and displayed in the previously selected region. Once the mashable component 126 has been injected into the UI element 410, it is stored as part of the personalization settings of the application 122. Accordingly, the injected mashable component 126 operates as a part of the application 126 because it is associated with the application's personalization settings.

In addition to injecting a mashable component 126 into an application UI, the UI framework 128 can also be configured to tag data in an application 122 even if the application does not support data tagging. As with injecting a mashable component 126 into the application, the UI framework 128 utilizes the persistent personalization settings of the application 122 to implement data tagging without modifying the application 122. At a high level, the UI framework 128 provides a mechanism for receiving and storing tagging data associated with a particular UI element in the application UI by saving the tagging data in connection with the data object represented in the UI element rather than in connection with the UI element. The tagging data is stored as personalization data in the persistent personalization settings, and all other UI elements which are bound to the data object can use the tagging data.

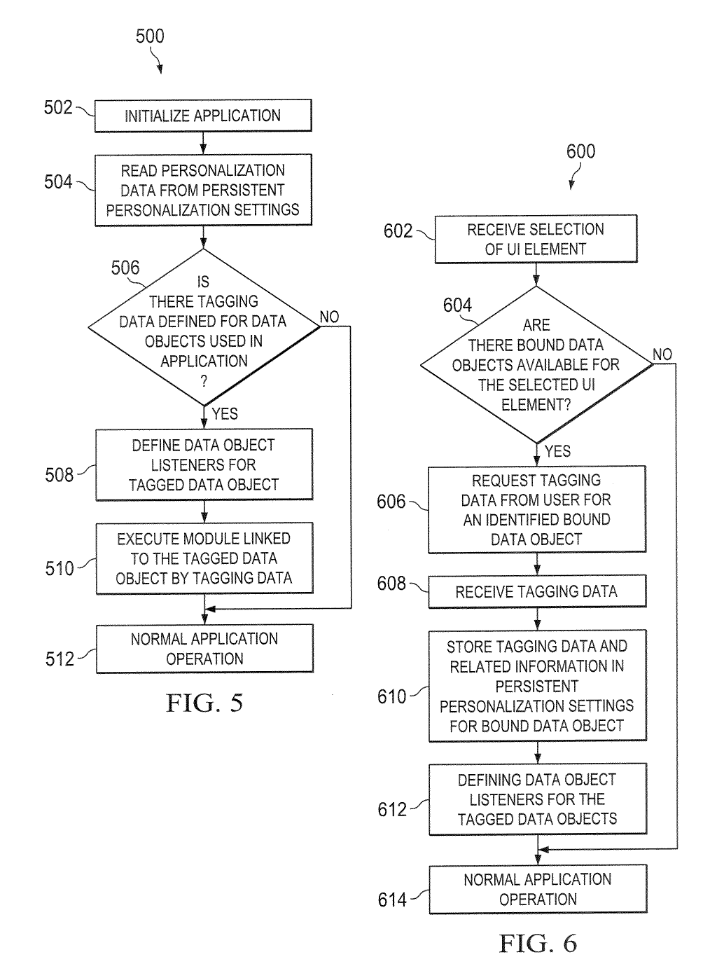

FIG. 5 is a flow chart illustrating the initialization process 500 of an application that already contains data objects that have been tagged according to the process of the present disclosure. The application 122 is started at 502. The application's UI framework 128 reads personalization data from the persistent personalization settings 124 for the application 122 at 504. The persistent personalization settings 124 are generally used by the application 122 for personalization of the application's 122 interface and settings. In some implementations, the application 122 can load the personalization settings 124 for the user at runtime of the application 122 to generate the appropriate interface for the user of the application 122. The personalization settings 124 can also be used to store tagging data associated with data objects and information related to UI elements bound to the data objects. Thus, if a data object has previously been associated with tagging data, the personalization settings 124 would include personalization data specific to the data object and the tagging data associated with the data object.

At 506, the application's UI framework 128 determines whether the personalization settings indicate tagging data that has been defined for any data objects used by application 122. If tagging data has not been defined for data objects used in the application 122, then the application 122 is executed under normal operations at 512. If personalization data is stored in the personalization settings 124 in connection with data objects associated with tagging data, the application's UI framework 128 executes the tagging data by defining data object listeners for the tagged data objects at 508. A data object listener, also called an event listener or an event handler, is a particular kind of object or function in a computer program that is executed in response to a specific event. Specifically, in certain implementations, a data object listener is defined for a particular tagged data object such that when the tagged data object is modified or accessed by an application, such as hosted application 122, an appropriate response is executed in connection with the tagged data object. In one example, a data object can be tagged with data that links the data object to a module such as a search function. Selection of the data object results in execution of an online search for terms related to the data object. Based on the listener function defined for the data object, a different selection of a UI element bound to the data object can automatically result in a new search performed for terms related to any new data objects in the selected UI element. Returning to FIG. 5, after a data object listener has been defined for the tagged data object, a module that is linked to the data object based on the data object's tagging data can be executed at 510, and the application 122 continues under normal operation at 512.

FIG. 6 is a flow chart illustrating the process 600 of adding a new tag to a data object. At 602, a user selects a UI element that is visible on the application UI for the purpose of adding a new tag to the UI element. The selection of the UI element can be done using various mechanisms. For example, a context menu can be used to provide a plurality of selections to the user, giving the user extended functionality while using the application 122 based on the selection of the particular UI element. After selection of a UI element, the application's UI framework 128 determines whether a bound data object is available for the selected UI element at 604. In some implementations, a data object may be referred to as being bound to a particular UI element when the data object is represented visually in a field contained in the UI element. Here, if the UI element is not bound to a data object, the UI framework 128 will not be able to store tagging data for a particular data object, and the application 122 continues under normal operations at 614. If the UI element contains a bound data object, the UI framework 128 requests tagging data from the user at 606 and receives the tagging data at 608. After receiving the tagging data, the tagging data and information relating to any associated UI elements are stored in the persistent personalization settings for the application 122 as any other personalization data for that application 122 at 510. The tagging data can be stored in the persistent personalization settings as a single attribute of a complex structure or even the whole structure. Further, the tagging data can be specified by a unique key such as the context path of the personalization data. Thus, because the tagging of data objects is implemented using the personalization settings of the application 122, tagging data can be given to data objects without modifying the application 122. Once the tagging data is stored in the personalization settings, the tagging data is applied to the particular bound data object, including defining a data object listener for the data object at 612. After the data object listeners are defined for the data object, the application 122 resumes normal operations at 614.

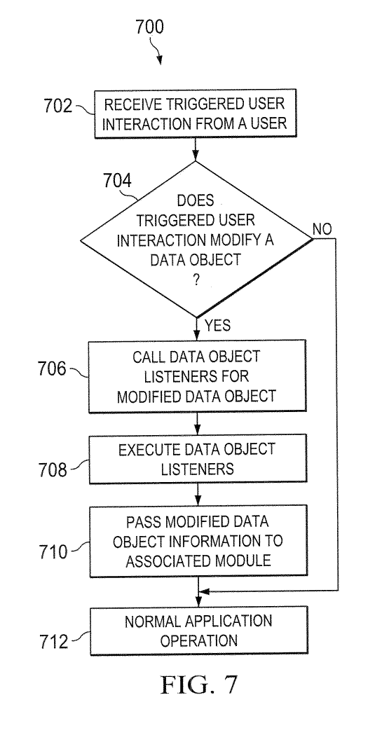

FIG. 7 is a flow chart illustrating the processing 700 of tagged data. At 702, a user triggers a type of user interaction with a UI element within the application UI such as, for example, selecting the UI element with a user interface device or changing the selection in a table. The application's UI framework 128 determines if the triggered user interaction results in a change in value to the tagged data object associated with the UI element or a selection of the tagged data object at 704. If the triggered user interaction does not modify or select the data object, then the application 122 continues under normal operations at 712. In either case, if the tagged data object has either been modified or selected, a data object listener that was previously defined for the data object is called and executed at 706 and 708. In certain implementations, the data object listener passes along any changes to a tagged data object to associated applications or functions. For example, if the tagging data for a particular data object links the data object to an online search application and the data object is modified, the data object listener may update the search function using the new value of the data object. As another example, a user may select a first data object that has been tagged and linked to a search application. When the user selects a second data object that has been tagged and linked to the search application, the selection of the second data object automatically triggers the data object listener and updates the search function with the second data object. Accordingly, execution of the tagging is completed when the changes to the data object are passed to the module or application linked to the data object via tagging data at 710 and the application 122 returns to normal operations at 712.

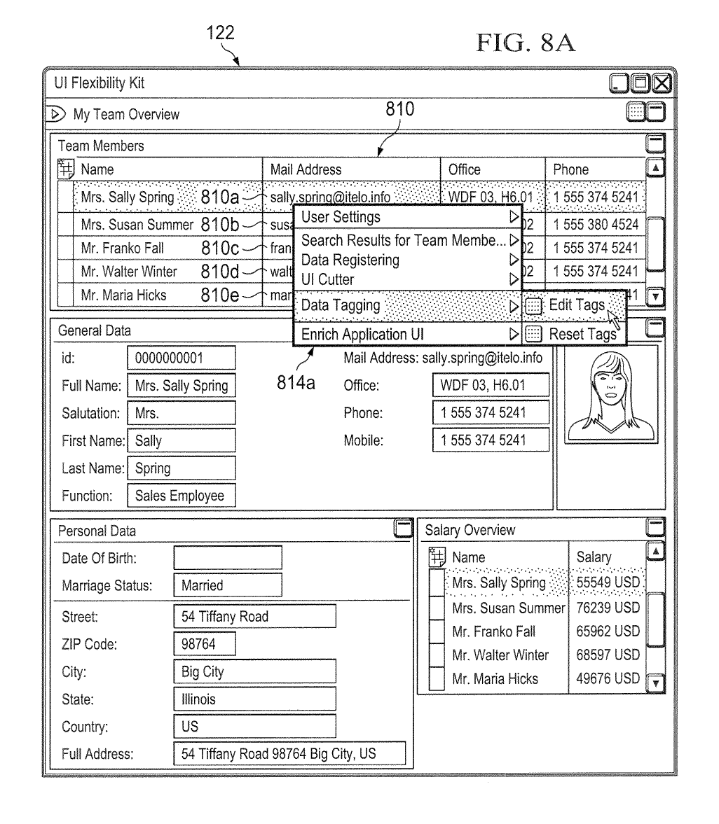

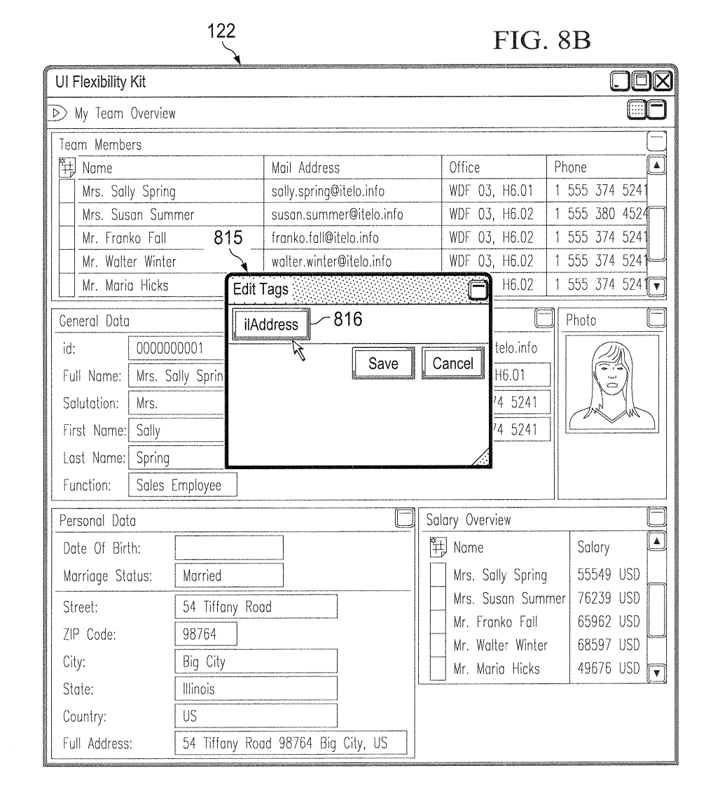

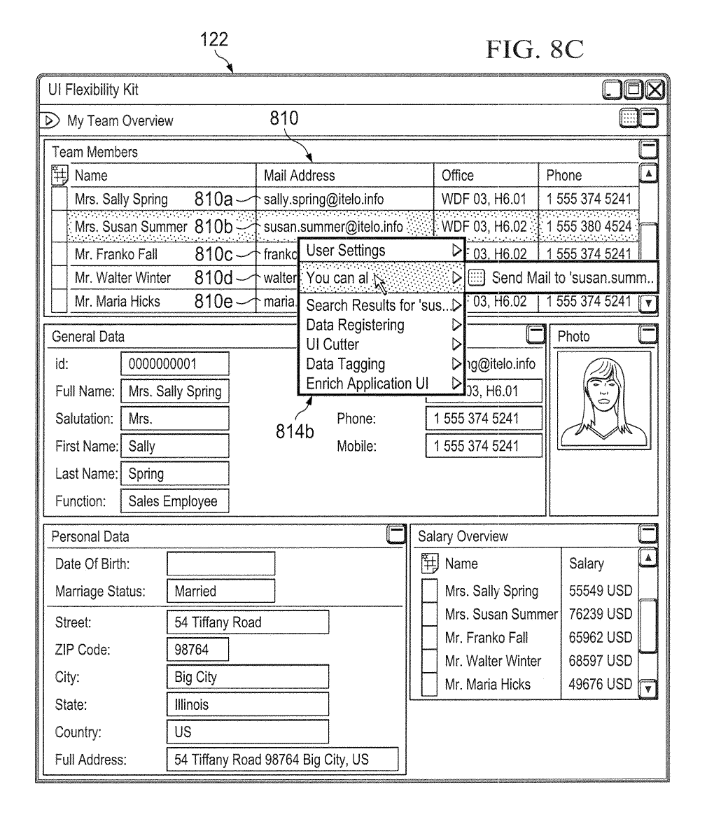

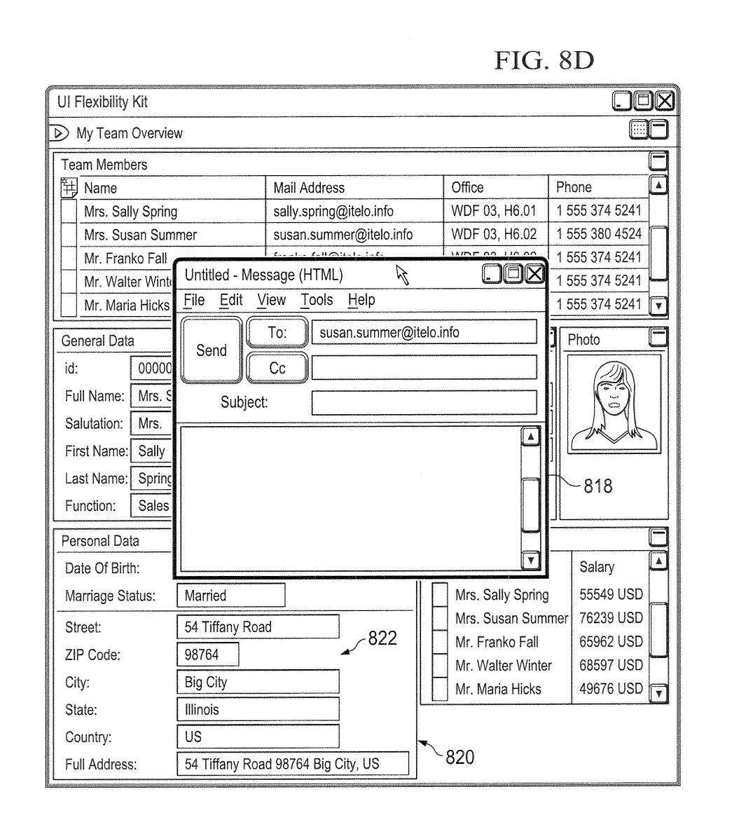

FIGS. 8A-8D depict an example process of enriching application elements through tagging of UI elements in an application UI. In the illustrated implementation, UI elements comprising team members' email addresses are tagged to associate the UI elements with execution of an email application, allowing the user to directly send emails to the email addresses without modifying or exiting the running application. First, as seen in FIG. 8A, a user selects a particular UI element 810a to be tagged. The UI element 810 in the illustrated example is a text field comprising email addresses of team members. The user's selection of the UI element can bring up a context menu 814a to provide the user with a list of options, including an option to enter tagging data for the selected UI element.

As depicted in FIG. 8B, after selection of the UI element 810a, a user is presented with a dialog box 815 to enter tagging data for the UI element 810. Here, the UI element 810a containing email addresses is tagged with an identifier 816 of an email application to be associated with the UI element 810a. The identifier 816 can be the name of an input port of the email application, and data objects that have been tagged with the identifier 816 can be wired to or associated with the email application. All underlying data objects associated with UI element 810 are then associated with the identifier 816, and the tagging data is stored in the personalization settings of the application 122. After the user has entered the tagging data for the UI element 810a, all UI elements 810 are associated with the email application. Thus, in FIG. 8C, the user selects another of the UI elements 810b, and a context menu 814b is presented that includes an option to execute an email application for the email address in UI element 810b. As illustrated in FIG. 8D, the email application 818 is executed to allow the user to email the particular email address contained in UI element 810b. The present disclosure also contemplates other implementations of modification free tagging of UI elements. For example, in FIG. 8D, the user can tag the address 822 located under Personal Data in UI element 820 with an address mapping identifier. The address in UI element 820 can then be associated with an address mapping application so that the user can execute the address mapping application to view a map of the area surrounding the address 822.

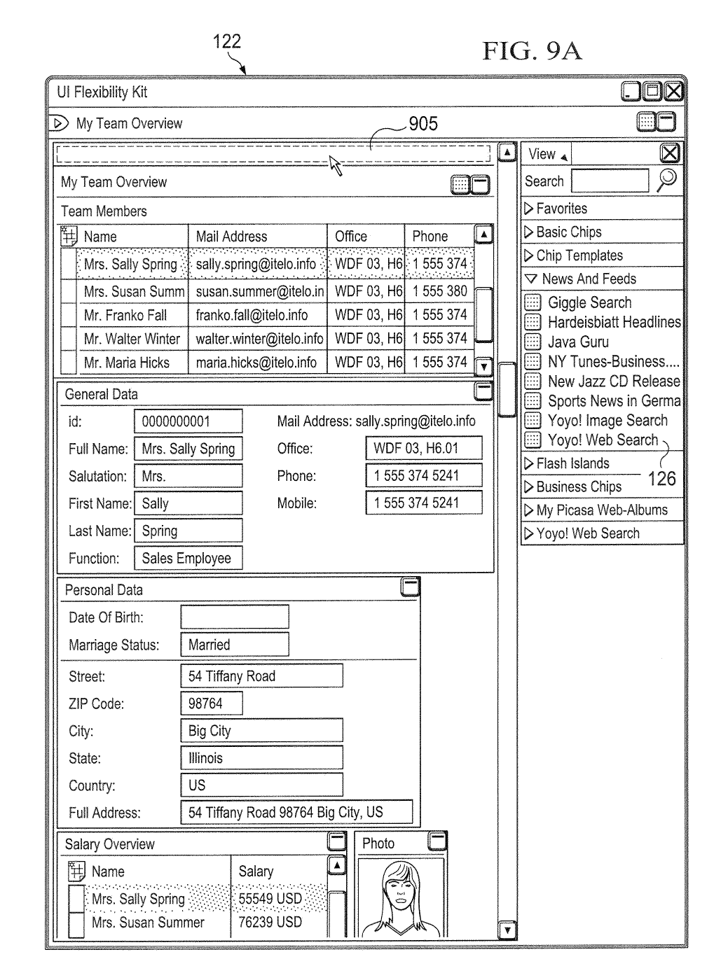

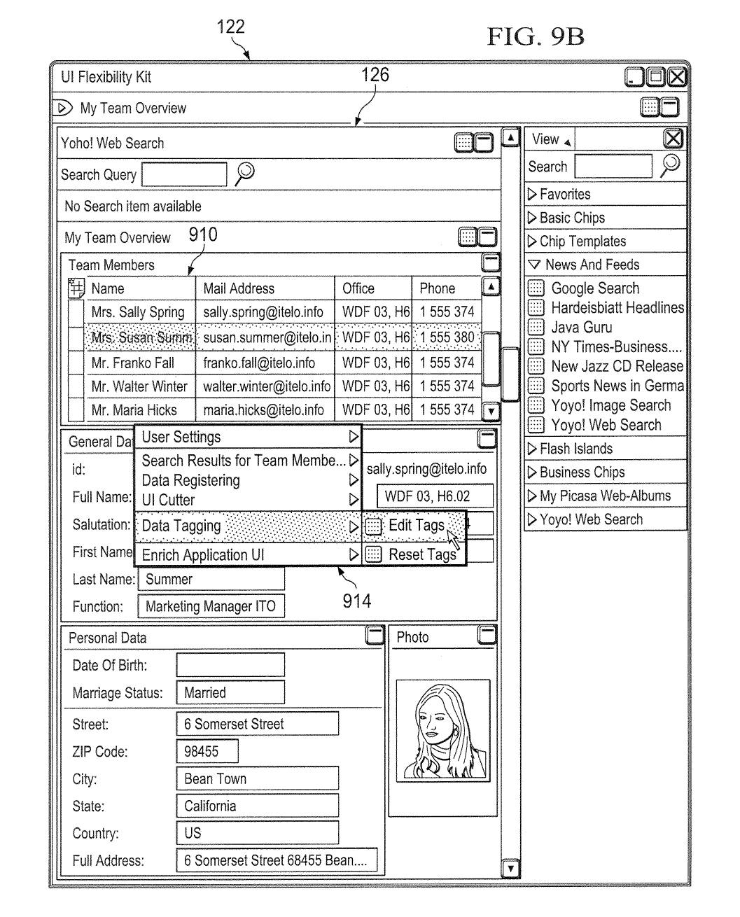

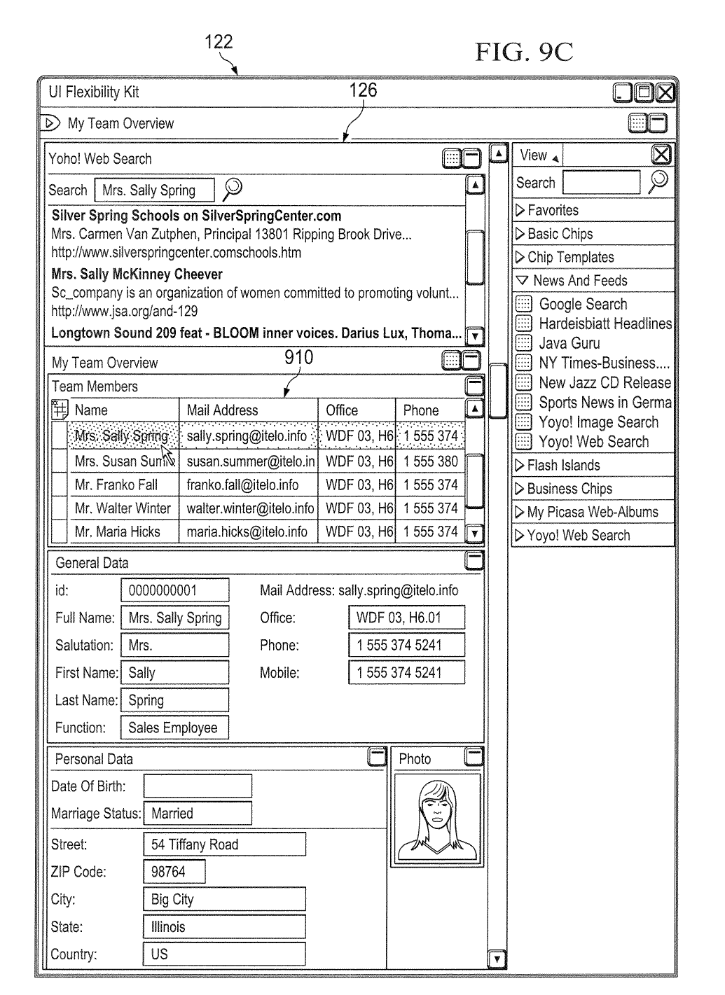

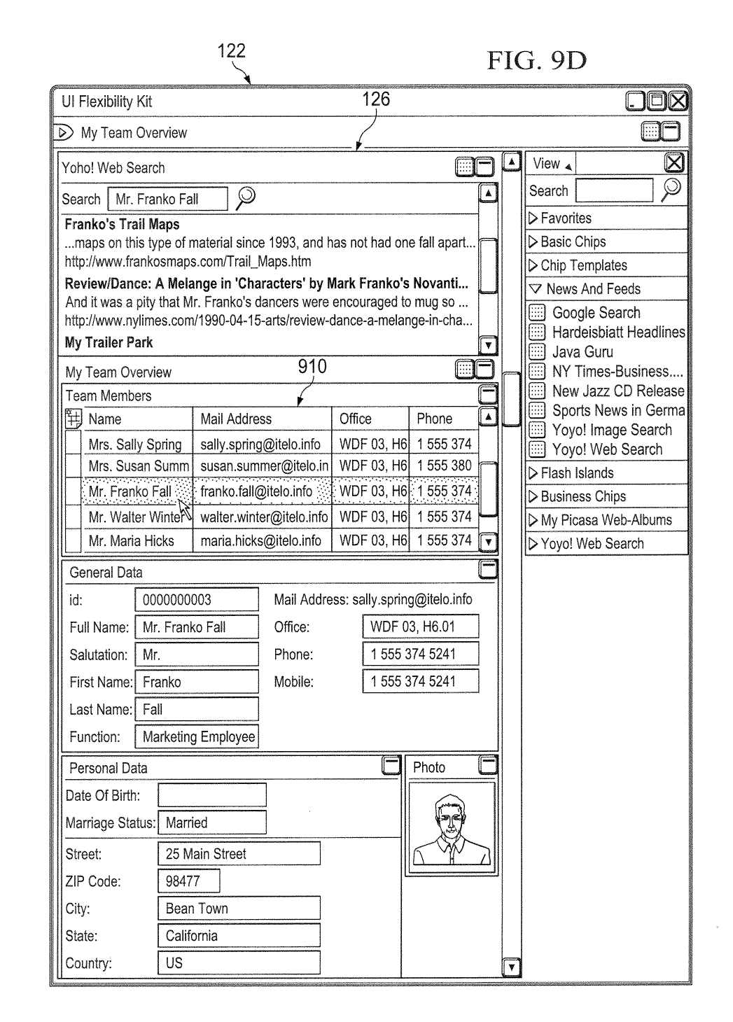

Still further, in some implementations, the modification free tagging of UI elements can be implemented in conjunction with the modification free UI injection process of the present disclosure as seen in FIGS. 9A-9D. Thus, as described above with respect to FIGS. 2, 3, and 4A-C, a mashable component 126 can be injected into a portion of the application UI. The injected mashable component 126 operates as a component within the application 126 and can then be tagged and wired to other components of the application 126 in accordance with the description of FIGS. 5, 6, 7, and 8A-8D so that the mashable component 126 can use data from the other components. As seen in FIG. 9A, a user can inject a mashable component 126 into a part 905 of the application UI using a context menu selection, a drag-and-drop mechanism, or other method. After the mashable component 126 has been injected into the application UI, the mashable component 126 is implemented as a part of the application 122 through the application's personalization settings. In the illustrated example, the mashable component 126 relates to an online search application. After the mashable component 126 has been injected into the application interface, the user can apply a tag to a UI element 910 in the application, such as the names of the team members, by selecting a tagging option from a context menu 914 as depicted in FIG. 9B. The tagging data can comprise an identifier that associates data objects contained in UI elements 910 with the online search application represented in the injected mashable component 126. Thus, each name contained in the UI elements 910 is wired to and associated with the online search application 126, and, as illustrated in FIGS. 9C and 9D, the user can execute the tag by selecting different UI elements 910. Further, different selections of different names in the UI elements 910 result in automatic updating of the search results displayed in the mashable component 126.

The preceding figures and accompanying description illustrate example processes and computer implementable techniques. But environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the steps in these processes may take place simultaneously and/or in different orders than as shown. Moreover, environment 100 may use processes with additional steps, fewer steps, and/or different steps, so long as the methods remain appropriate. For example, example method 600 describes the linking of tagging data from a data object to a particular application so that the application can be executed using the data object. In certain implementations, the particular application that is linked to the data object can be a mashable component injected into the hosted application 122 using the modification free UI injection techniques of the present disclosure.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computer implemented method for causing one or more processors to apply tagging data to a data object used by an application, the method comprising the following steps performed by the one or more processors:
identify a selection of a particular user interface element of the application for tagging;
if at least one bound data object is associated with the particular user interface element, receive tagging data associated with the at least one bound data object;
store the tagging data in personalization settings of the application; and
define a listener function associated with the bound data object.

2. The method of claim 1, wherein the tagging data defines a relation between the bound data object and a component of a disparate application.

3. The method of claim 2, wherein the tagging data comprises an identifier of an input value to the component of the disparate application.

4. The method of claim 2, wherein the component of the disparate application is executed with the bound data object as an input.

5. The method of claim 2, wherein the component of the disparate application is a mashup component injected into a user interface of the application.

6. The method of claim 2, further comprising executing the listener function after a triggered user interaction.

7. The method of claim 6, wherein the triggered user interaction comprises modification of the bound data object.

8. The method of claim 7, wherein the execution of the listener function comprises passing the modified bound data object to the component of the disparate application.

9. The method of claim 4, wherein the component of the disparate application is executed with a second bound data object as the input after receiving selection of the second bound data object.

10. A computer program product encoded on a tangible storage medium, the product comprising computer readable instructions for causing one or more processors to perform operations comprising:
identify a selection of a particular user interface element of an application for tagging;
if at least one bound data object is associated with the particular user interface element, receive tagging data for the bound data object;
store tagging data in personalization settings of the application; and
define a listener function associated with the bound data object.

11. The computer program product of claim 10, wherein the tagging data defines a relation between the bound data object and a component of a disparate application.

12. The computer program product of claim 11, wherein the tagging data comprises an identifier of an input value to the component of the disparate application.

13. The computer program product of claim 11, wherein the component of the disparate application is executed with the bound data object as an input.

14. The computer program product of claim 11, wherein the component of the disparate application is a mashup component injected into a user interface of the application.

15. The computer program product of claim 11, further comprising executing the listener function after a triggered user interaction.

16. The computer program product of claim 15, wherein the triggered user interaction comprises modification of the bound data object.

17. The computer program product of claim 16, wherein the execution of the listener function comprises passing the modified bound data object to the component of the disparate application.

18. The computer program product of claim 13, wherein the component of the disparate application is executed with a second bound data object as the input after receiving selection of the second bound data object.
